(19) United States
(12) Patent Application Publication
(10) Pub. No.: US 2005/0036555 A1
(43) Pub. Date: Feb. 17, 2005

(54) Automatic direct memory access engine

(76) Inventor: Lakshmanan Ramakrishnan, Bangalore (IN)

Correspondence Address: MCANDREWS HELD & MALLOY, LTD, 500 WEST MADISON STREET, SUITE 3400, CHICAGO, IL, 60661, US

(21) Appl. No.: 10/765,813

(22) Filed: Jan. 27, 2004

Related U.S. Application Data
(60) Provisional application No. 60/494,753, filed on Aug. 13, 2003.

(51) Int. Cl. H04N 7/12

(52) U.S. Cl. 375/240.25; 375/240.24

(57) ABSTRACT

Presented herein is an automatic direct memory access engine. In one embodiment, a decoder system for decoding video data, comprises a video decoder and a direct memory access engine. The video decoder decodes portions of the video data and comprises a local buffer and an extractor. The local buffer stores the portions of the video data. The extractor transmits a signal indicating that a portion of the local buffer is available to store another portion of the video data. The direct memory access engine provides the another portion of the video data to the portion of the local buffer, responsive to receiving the signal from the extractor.

### RELATED APPLICATIONS

The application claims priority to Provisional Application for U.S. Patent, Ser. No. 60/494,753, entitled “Automatic Direct Memory Access Engine”, filed Aug. 13, 2003 by Lakshmanan Ramakrishnan.

### FEDERALLY SPONSORED RESEARCH OR DEVELOPMENT

[Not Applicable]

[MICROFICHE/COPYRIGHT REFERENCE]

[Not Applicable]

### BACKGROUND OF THE INVENTION

In MPEG-2, frames are decoded on a macroblock by macroblock basis. Compressed video data is stored in a compressed data buffer to await decoding decompression by a video decoder. The video decoder decodes the video data in real time. The video decoder receives the video data by fetching portions of the video data from the compressed data buffer. The video decoder generally has much less memory than the compressed data buffer, and accordingly, fetches the video data in portions. After fetching a portion of the video data, the video decoder decodes the portion and stores the decoded portion. After decoding and storing a portion of the video data, the video decoder then fetches another portion.

The video data can have varying compression ratios. In cases where the video data has a high compression rate, the video decoder has fewer fetches. In cases where the video data has a low compression rate, the video decoder has more fetches. As the number of fetches increase, more of the video decoder processing power is expended fetching the video data from the compressed data buffer. This makes it difficult to decode the video data in real time.

Further limitations and disadvantages of conventional and traditional systems will become apparent to one of skill in the art through comparison of such systems with the invention as set forth in the remainder of the present application with reference to the drawings.

### BRIEF SUMMARY OF THE INVENTION

Presented herein is an automatic direct memory access engine. In one embodiment, there is a method for providing data. The method comprises receiving a command from a node to provide data starting from an address, providing data starting from the address and ending at a first address, receiving an indication that the node can receive additional data, and providing data starting from the first address and ending at a second address after receiving the indication.

In another embodiment, there is a method for providing video data to a video decoder. The method comprises receiving a first request for a first macroblock row, receiving a second request for a second macroblock, providing successive portions of the first macroblock row after receiving the first request and an indication that the video decoder has decoded a previous portion of the first macroblock row, and providing successive portions of the second macroblock row after receiving the second request and an indication that the video decoder has decoded a previous portion of the second macroblock row, while providing successive portions of the first macroblock row.

In another embodiment, there is presented a video decoder for decoding video data. The video decoder comprises a local buffer, a decompression engine, and an extractor. The local buffer stores a portion of the video data. The decompression engine decodes the portion of the video data stored in the local buffer. The extractor transmit an indicator to a direct memory access engine indicating that the local buffer can store another portion of the video data, after the decompression engine decodes the portions of the video data stored in the local buffer.

In another embodiment, there is a direct memory access engine for providing data. The direct memory access engine comprises state logic. The state logic is operable to receive a command from a node to provide data starting from an address, provide data starting from the address and ending at a first address, receive an indication that the node can receive additional data, and provide data starting from the first address and ending at a second address after receiving the indication.

In another embodiment, there is presented a direct memory access engine for providing video data to a video decoder. The direct memory access engine comprises state logic. The state logic is operable to receive a first request for a first macroblock row, receive a second request for a second macroblock, provide successive portions of the first macroblock row after receiving the first request and an indication that the video decoder has decoded a previous portion of the first macroblock row, and provide successive portions of the second macroblock row after receiving the second request and an indication that the video decoder has decoded a previous portion of the second macroblock row, while providing successive portions of the first macroblock row.

In another embodiment, there is presented a decoder system for decoding video data. The decoder system comprises a video decoder and a direct memory access engine. The video decoder for decodes portions of the video data and comprises a local buffer and an extractor. The local buffer stores the portions of the video data. The extractor transmits a signal indicating that a portion of the local buffer is available to store another portion of the video data. The direct memory access engine provides another portion of the video data to the portion of the local buffer, after receiving the signal from the extractor.

These and other novel features of the present invention, as well as details of illustrated embodiments thereof, will be more fully understood from he following description and drawings.

### BRIEF DESCRIPTION OF SEVERAL VIEWS OF THE DRAWINGS

FIG. 1 is a block diagram describing the encoding of video data in accordance with the MPEG-2 standard;

FIG. 2 is a block diagram of an exemplary decoder system in accordance with an embodiment of the present invention;

FIG. 3 is a block diagram describing the decoding of a frame;

FIG. 4 is a block diagram of a direct memory access engine in accordance with an embodiment of the present invention;

FIG. 5 is a flow diagram for decoding in accordance with an embodiment of the present invention; and

FIG. 6 is a block diagram of a direct memory access engine for decoding multiple macroblock rows in accordance with an embodiment of the present invention.

### DETAILED DESCRIPTION OF THE INVENTION

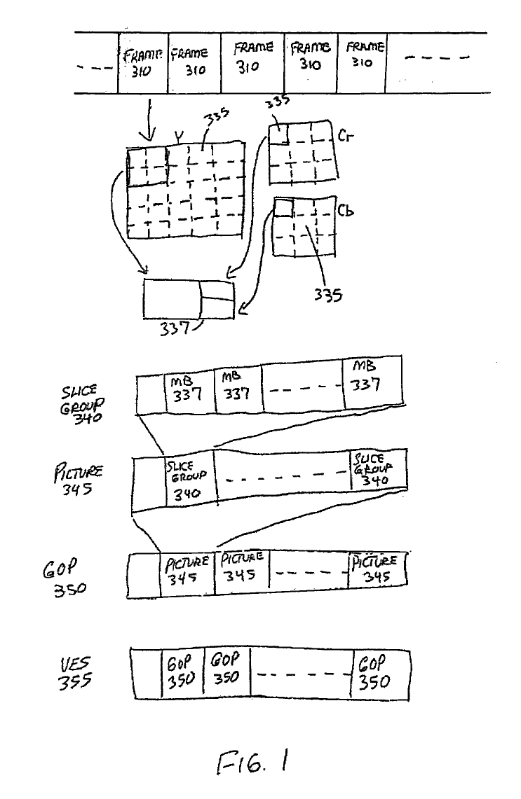

Referring now to FIG. 1, there is illustrated a block diagram describing MPEG formatting of a video sequence 305. A video sequence 305 comprises a series of frames 310. Each frame comprises two dimensional grids of luminance Y, chroma red Cr, and chroma blue Cb pixels 315. The two-dimensional grids are divided into 8×8 blocks 335, where four blocks 335 of luminance pixels Y are associated with a block 335 of chroma red Cr, and a block 335 of chroma blue Cb pixels. The four blocks of luminance pixels Y, the block of chroma red Cr, and the chroma blue Cb form a data structure known as a macroblock 337. The macroblock 337 also includes additional parameters, including motion vectors.

The macroblocks 337 representing a frame are grouped into different slice groups 340. The slice group 340 includes the macroblocks 337 in the slice group 340, as well as additional parameters describing the slice group. Each of the slice groups 340 forming the frame form the data portion of a picture structure 345. The picture 345 includes the slice groups 340 as well as additional parameters. The pictures are then grouped together as a group of pictures 350. The group of pictures 350 also includes additional parameters. Groups of pictures 350 are then stored, forming what is known as a video elementary stream 355. The video elementary stream 355 is then packetized to form a packetized elementary sequence 360. Each packet is then associated with a transport header 365a, forming what are known as transport packets 365b.

The transport packets 365b can be multiplexed with other transport packets 365b carrying other content, such as another video elementary stream 355 or an audio elementary stream. The multiplexed transport packets from what is known as a transport stream. The transport stream is transmitted over a communication medium for decoding and presentation.

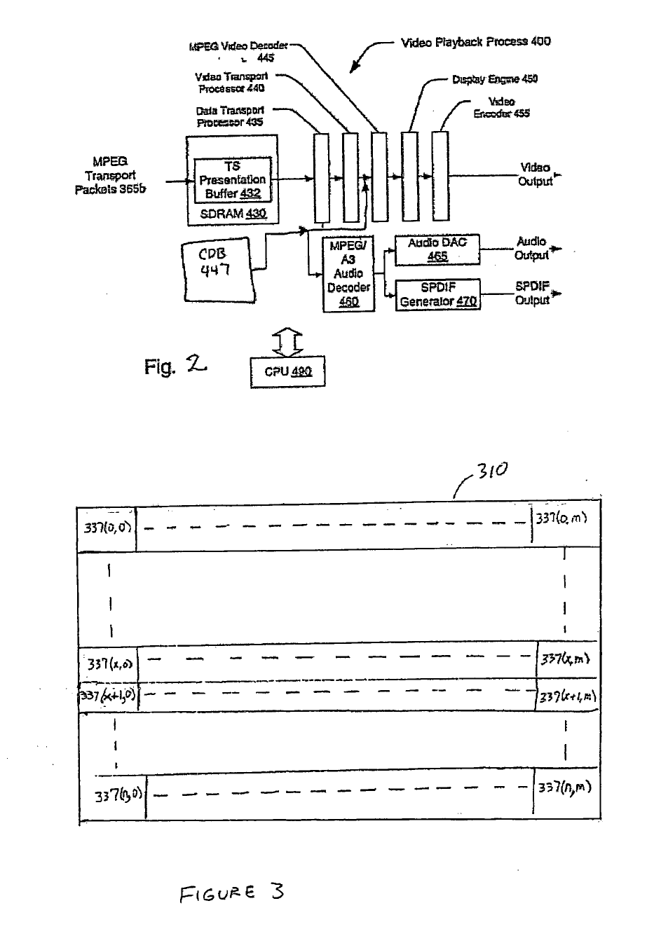

Referring now to FIG. 2, there is illustrated a block diagram of an exemplary decoder for decoding compressed video data, configured in accordance with an embodiment of the present invention. A processor, that may include a CPU 490, reads a stream of transport packets 365b (a transport stream) into a transport stream buffer 432 within an SDRAM 430.

The data is output from the transport stream presentation buffer 432 and is then passed to a data transport processor 435. The data transport processor then demultiplexes the MPEG transport stream into its PES constituents and passes the audio transport stream to an audio decoder 460 and the video transport stream to a video transport processor 440.

The video transport processor 440 converts the video transport stream into a video elementary stream and provides the video elementary stream to an MPEG video decoder 445 that decodes the video. The video elementary stream 355 is stored in a compressed data buffer (CDB) 447. The MPEG video decoder 445 accesses the compressed data buffer (CDB) to receive the video elementary stream 355. The video elementary stream 355 is decoded by the MPEG video decoder 445 resulting in the reconstructed video sequence 305.

The audio data is sent to the output blocks and the video sequence 305 is sent to a display engine 450. The display engine 450 is responsible for and operable to scale the video picture, render the graphics, and construct the complete display among other functions. Once the display is ready to be presented, it is passed to a video encoder 455 where it is converted to analog video using an internal digital to analog converter (DAC). The digital audio is converted to analog in the audio digital to analog converter (DAC) 465.

The MPEG video decoder 445 decodes the video elementary stream 355 in real time. The MPEG video decoder 445 receives the video data by fetching portions of the video elementary stream 355 from the compressed data buffer 447. The MPEG video decoder 445 generally has much less memory than the compressed data buffer 447, and accordingly, fetches the video elementary stream 355 in portions. After fetching a portion from the video elementary stream 355, the MPEG video decoder 445 decodes the portion and stores the decoded portion. After decoding and storing a portion of the video elementary stream 355, the MPEG video decoder 445 then fetches another portion.

Referring now to FIG. 3, there is illustrated a block diagram describing the decoding of a frame 310. The frame 310 comprises any number of macroblock 337 rows. The MPEG video decoder 445 decodes the frame 310 in units of macroblocks 337, beginning with the top left macroblock 337 (0, 0), and proceeding from left to right across each row from top to bottom towards the bottom right macroblock 337(n, m).

Referring again to FIG. 2, the MPEG video decoder 445 decodes the video elementary stream 355 in real time. The MPEG video decoder 445 receives the video data by fetching portions of the video elementary stream 355 from the compressed data buffer 447. The MPEG video decoder 445 generally has much less memory than the compressed data buffer 447, and accordingly, fetches the video elementary stream 355 in portions. After fetching a portion from the video elementary stream 355, the MPEG video decoder 445 decodes the portion and stores the decoded portion. After decoding and storing a portion of the video elementary stream 355, the MPEG video decoder 445 then fetches another portion.

The video elementary stream 355 can have varying compression ratios. In cases where the video elementary stream 355 has a high compression rate, the MPEG video decoder 445 has fewer fetches. In cases where the video elementary stream 355 has a low compression rate, the MPEG video decoder 445 has more fetches.

In order to preserve the MPEG video decoder 445 processing power, the decoder system is capable of operation in an automatic direct memory access (DMA) mode. In the automatic DMA mode of operation, the MPEG video decoder 445 begins decoding a row of macroblocks 337 by making a single request. Responsive to making the single request, the row of macroblocks 337 is provided to the MPEG video decoder 445. The row of macroblocks 337 is provided in portions to the MPEG video decoder 445. When the MPEG video decoder 445 decodes and stores a provided portion, the MPEG video decoder 445 can receive an additional portion. The next portion is automatically provided to the MPEG video decoder 445.

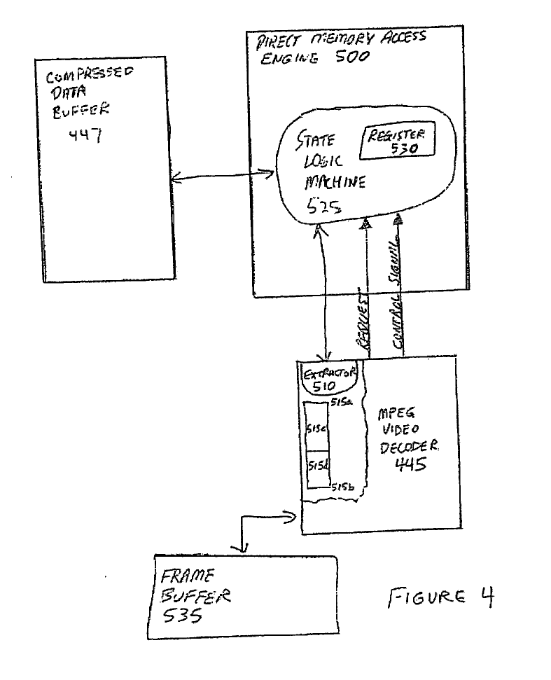

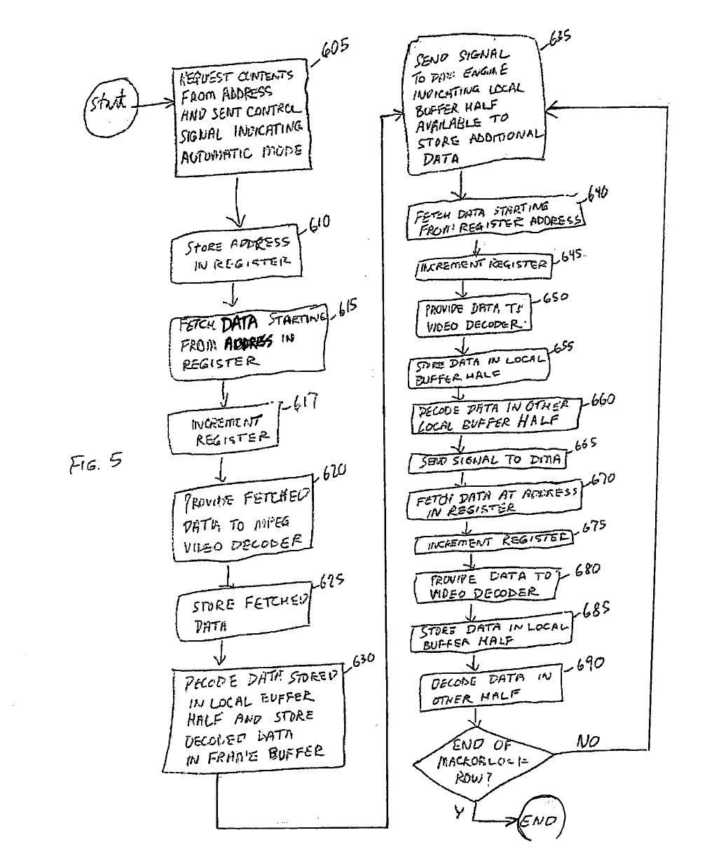

Referring now to FIG. 4, there is illustrated a block diagram of an exemplary direct memory access (DMA) engine 500 in accordance with an embodiment of the present invention. The DMA engine 500 is capable of operation in two modes—a basic mode and an automatic direct memory access mode.

In the basic mode of operation, the MPEG video decoder 445 via decompression engine 452 therein, provides the DMA engine 500 with a request for the contents of a certain range of addresses in the compressed data buffer 447. Responsive thereto, the DMA engine 500 provides the contents of the range of addresses to the MPEG video decoder 445.

The MPEG video decoder 445 includes an extractor 510 and a local buffer 515 for receiving data from the DMA engine 500. Generally, the local buffer 515 has a limited amount of memory, on the order of 256-1024 bytes. Accordingly, the amount of data that can be provided to the MPEG video decoder 445 in the basic mode is limited by the available memory in the local buffer 515.

As noted above, the MPEG video decoder 445 via decompression engine 452 decodes a frame 310 in macroblocks 337. Limitations on the amounts of data that can be provided to the MPEG video decoder 445 per request, can require more data requests by the decompression engine 452 to the compressed data buffer 447 to decode a frame 310. To reduce the number of data requests that the decompression engine 452 makes to decode a frame 310, the DMA engine 500 is capable of operation in an automatic mode.

In the automatic mode of operation, the decompression engine 452 begins decoding a macroblock row, by making a request for the address storing the start of the first macroblock 337 (x, 0) in the row accompanied by a control signal indicating that the DMA engine 500 is to operate in the automatic mode. The compressed data buffer 447 stores a start code table 520 that indicates the starting address of each macroblock row.

The DMA engine 500 comprises a state logic machine 525 that receives the request, as well as the accompanying control signal. Responsive thereto, the state logic machine 525 stores the beginning address in a register 530 and fetches data starting from the beginning address. The amount of data that is fetched is equivalent to the amount of memory in the local buffer 515. After fetching the data, the state logic machine 525 increments the register 530 to reflect the next address to access in the compressed data buffer 447. The fetched data is provided to the extractor 510 and stored in the local buffer 515. The decompression engine 452 decodes the data that is stored in the local buffer 515, and stores the decoded data in a frame buffer 535. The decompression engine 452 can proceed from the beginning of the local buffer 515a to the ending of the local buffer 515b, and wrap around back to the beginning of the local buffer 515a. As the decompression engine 452 decodes data from the local buffer 515 and stores the decoded data in the frame buffer 535, the portions of the local buffer 515 that store the decoded data are available for storing additional data.

The local buffer 515 can be divided into two halves, half 515c comprising the beginning of the local buffer 515a, and half 515d comprising the ending of the local buffer 515b. When the decompression engine 452 has decoded the data stored in half 515c and stored the decoded data in the frame buffer 535, the decompression engine 452 decodes the data stored in half 515d. Additionally, the memory in local buffer half 515c is available to store additional data. Accordingly, the extractor 510 sends a signal to the DMA engine 500 indicating that a buffer half 515c is available for storing additional memory. The signal is received by the state logic machine 525, and responsive thereto, the state logic machine 525 fetches data starting from the address stored in the register 530. The amount of data that is fetched is equivalent to the memory capacity of a local buffer half 515c. The register 530 is incremented to reflect the next address to fetch from the compressed data buffer 447. The data is then provided to the MPEG video decoder 445 and stored in the local buffer half 515c.

When the decompression engine 452 decodes the data stored in half 515d and stores the decoded data in the frame buffer 535, the decompression engine 452 decodes the data stored in half 515c. As described above, new data will have been stored for decoding in half 515c. Additionally, the memory in local buffer half 515d is available to store additional data. Accordingly, the extractor 510 sends a signal to the DMA engine 500 indicating that a buffer half 515d is available for storing additional memory. The signal is received by the state logic machine 525, and responsive thereto, the state logic machine 525 fetches data starting from the address stored in the register 530. The amount of data that is fetched is equivalent to the memory capacity of a local buffer half 515d. The register 530 is incremented to reflect the next address to fetch from the compressed data buffer 447. The data is then provided to the MPEG video decoder 445 and stored in the local buffer half 515d.

The foregoing is repeated until the data representing the end of the macroblock row is provided, e.g., the end of macroblock 337(x, m). The foregoing condition can be detected by comparing the contents of the register 530 to the starting address of the next macroblock row, e.g., macroblock 337(x+1, 0) in the start code table 520. When the contents of the register 530 are equal to or greater than the starting address of the next macroblock row, the present macroblock row has been provided to the MPEG video decoder 445.

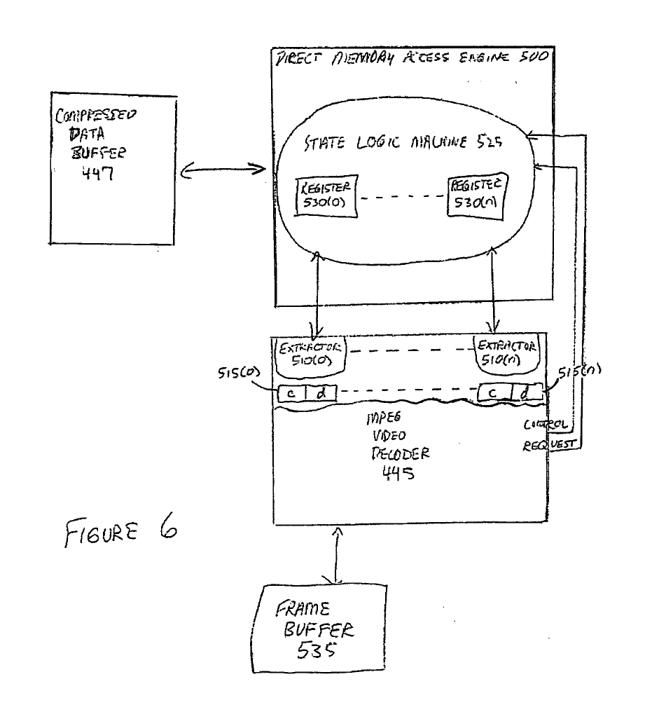

Referring now to FIG. 5, there is illustrated a flow diagram for decoding a macroblock row in accordance with an embodiment of the present invention. At 605 the decompression engine 452 sends a request for the contents of an address location in the compressed data buffer 447 storing the beginning of a macroblock row, e.g., the beginning of macroblock 337 (x, 0), accompanied by a control signal indicating the automatic mode of operation.

Responsive thereto, the state logic machine 525 stores (610) the address in the register 530, and fetches (615) data starting from the address in the register 530. The amount of data fetched is equivalent to the capacity of the local buffer 515. The state logic machine 525 increments (617) the register 530 to reflect the next address to fetch from the compressed data buffer 447. The DMA engine 500 provides (620) the fetched data to the MPEG video decoder 445, and the MPEG video decoder 445 stores (625) the fetched data in the local buffer 515. The decompression engine 452 then decodes the data stored in local buffer half 515c and stores the decoded data in the frame buffer (630). When the decompression engine 452 decodes the data stored in local buffer half 515c, the extractor 510 sends (635) a signal to the DMA engine 500 indicating that local buffer half 515c is available to store additional data.

Responsive thereto, the state logic machine 525 fetches (640) data starting from the address in the register 530, and increments the register 530 (645). The amount of data fetched is equivalent to the memory capacity of local buffer half 515c. The DMA engine 500 provides (650) the data to the MPEG video decoder 445.

The MPEG video decoder 445 stores (655) the data in the local buffer half 515c and the decompression engine 452 proceeds to decode (660) the data in local buffer half 515d. After the decompression engine 452 decodes the data in local buffer half 515d, the extractor 510 sends (665) a signal to the DMA engine 500 indicating that local buffer half 515d is available to store additional data.

Responsive thereto, the state logic machine 525 fetches (670) data starting from the address in the register 530, and increments the register 530 (675). The amount of data fetched is equivalent to the memory capacity of local buffer half 515c. The DMA engine 500 provides (680) the data to the MPEG video decoder 445. The MPEG video decoder 445 stores (685) the data in the local buffer half 515d and the decompression engine 452 proceeds to decode (690) the data stored in local buffer half 515c during 655.

Until the end of the macroblock row is encountered, e.g., the end of macroblock 337(x, m), 635-690 are repeated.

As can be seen, the foregoing significantly offloads tasks associated with fetching data from the decompression engine 452 and conserves considerable processing power. The conservation of processing power allows the decompression engine 452 to more easily decode frames 305 in real time. Additionally, the foregoing scheme is scalable and can be implemented to allow the MPEG video decoder 445 to access multiple rows in parallel.

Referring now to FIG. 6, there is illustrated a block diagram of an exemplary direct memory access (DMA) engine 500 for allowing the MPEG video decoder 445 to decode multiple macroblock rows in accordance with an embodiment of the present invention.

The MPEG video decoder 445 comprises a decompression engine 452, multiple extractors 510(0) . . . 510(n) and associated local buffers 515(0) . . . 515(n). Similarly, the state machine logic 525 in the DMA engine 500 comprises multiple registers 530(0) . . . 530(n). The MPEG video decoder 445 can associate each of the extractors 510(0) . . . 510(n) and associated local buffers 515(0) . . . 515(n) with a particular macroblock row.

The MPEG video decoder 445 via decompression engine 452 can then command the DMA engine 500 to fetch data starting from the addresses storing the beginning of each macroblock row in the automatic mode. Responsive thereto, the DMA engine 500 stores each of the addresses in the registers 530(0) . . . 530(n), and associates a particular register 530 with each extractor 510 and associated local buffer 515.

The DMA engine 500 proceeds to provide the data for each macroblock row to each local buffer 515. When a local buffer half 515c, 515d is available to store additional data, the associated extractor 510 sends a signal indicating the same to the state logic machine 525. The state logic machine 525 fetches data starting at the address indicated in the register 530, associated with the requesting extractor 510, provides the data to the local buffer half 515c, 515d associated with the requesting extractor 510, and appropriately increments the register 530.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor can be implemented as part of an ASIC device with various functions implemented as firmware.

While the invention has been described with reference to certain embodiments, it will be understood by those skilled in the art that various changes may be made and equivalents may be substituted without departing from the scope of the invention. In addition, many modifications may be made to adapt particular situation or material to the teachings of the invention without departing from its scope. Therefore, it is intended that the invention not be limited to the particular embodiment(s) disclosed, but that the invention will include all embodiments falling within the scope of the appended claims.

1. A method for providing data, said method comprising:
receiving a command from a node to provide data starting from an address;
providing data starting from the address and ending at a first address;
receiving an indication that the node can receive additional data; and
providing data starting from the first address and ending at a second address after receiving the indication.

2. The method of claim 1, wherein the command is accompanied by a control signal indicating a particular mode of operation.

3. The method of claim 1, further comprising:
storing the starting address.

4. The method of claim 3, further comprising:
incrementing the starting address to equal the ending address.

5. A method for providing video data to a video decoder, said method comprising:
receiving a first request for a first macroblock row;
receiving a second request for a second macroblock;
providing successive portions of the first macroblock row after receiving the first request and an indication that the video decoder has decoded a previous portion of the first macroblock row; and
providing successive portions of the second macroblock row after receiving the second request and an indication that the video decoder has decoded a previous portion of the second macroblock row, while providing successive portions of the first macroblock row.

6. The method of claim 5, wherein the first request is accompanied by a starting address for the first macroblock row, and the second request is accompanied by a starting address for the second macroblock row, the method further comprising:
storing the first address; and
storing the second address.

7. The method of claim 6, wherein providing successive portions of the first macroblock row further comprises:
incrementing the first starting address to a first intermediate address after providing a first of the successive portions of the first macroblock row; and
incrementing the second starting address to a second intermediate address after providing a first of the successive portions of the second macroblock row.

8. The method of claim 7, wherein providing successive portions of the first macroblock row, further comprises:
providing a portion from the first macroblock row that begins at the first intermediate address, after incrementing the first starting address to the first intermediate address.

9. A video decoder for decoding video data, said video decoder comprising:
a local buffer for storing a portion of the video data;
a decompression engine for decoding the portion of the video data stored in the local buffer; and
an extractor for transmitting an indicator to a direct memory access engine indicating that the local buffer can store another portion of the video data, after the decompression engine decodes the portions of the video data stored in the local buffer.

10. The video decoder of claim 9, wherein the decompression engine transmits a command to the direct memory access engine.

11. The video decoder of claim 9, wherein the local buffer stores another portion of the video data after the extractor transmits the signal to the direct memory access engine.

12. The video decoder of claim 9, further comprising:
a second local buffer for storing a second portion of the video data while the first local buffer stores the portion of the video data; and
a second extractor for transmitting an indicator to a direct memory access engine indicating that the second local buffer can store another portion of the video data, after the decompression engine decodes the second portion of the video data stored in the second local buffer.

13. A direct memory access engine for providing data, the direct memory access engine comprising state logic that is operable to:
receive a command from a node to provide data starting from an address;
provide data starting from the address and ending at a first address;
receive an indication that the node can receive additional data; and
provide data starting from the first address and ending at a second address after receiving the indication.

14. The direct memory access engine of claim 13 further comprising:
a register for storing the starting address.

15. The direct memory access engine of claim 14, wherein the state logic machine is operable to increment the starting address to equal the ending address.

16. A direct memory access engine for providing video data to a video decoder, said direct memory access engine comprising state logic that is operable to:
receive a first request for a first macroblock row;
receive a second request for a second macroblock;
provide successive portions of the first macroblock row after receiving the first request and an indication that the video decoder has decoded a previous portion of the first macroblock row; and
provide successive portions of the second macroblock row after receiving the second request and an indication that the video decoder has decoded a previous portion of the second macroblock row, while providing successive portions of the first macroblock row.

17. The direct memory access engine 16, wherein the first request is accompanied by a starting address for the first macroblock row, and the second request is accompanied by a starting address for the second macroblock row, the direct memory access engine further comprising:
a first register for storing the first address; and
a second register for storing the second address.

18. The direct memory access engine of claim 17, wherein the state logic is operable to increment the first starting address to a first intermediate address after providing a first of the successive portions of the first macroblock row and increment the second starting address to a second intermediate address after providing a first of the successive portions of the second macroblock row.

19. The direct memory access engine of claim 18 wherein the state logic provides a portion from the first macroblock row that begins at the first intermediate address, after incrementing the first starting address to the first intermediate address.

20. A decoder system for decoding video data, said decoder system comprising:
a video decoder for decoding portions of the video data, said video decoder comprising:
a local buffer for storing the portions of the video data; and
an extractor for transmitting a signal indicating that a portion of the local buffer is available to store another portion of the video data; and
a direct memory access engine for providing the another portion of the video data to the portion of the local buffer, after receiving the signal from the extractor.
